(19) United States
(12) Patent Application Publication
(10) Pub. No.: US 2025/0029993 A1
(43) Pub. Date: Jan. 23, 2025

(54) COMPOSITE ACTIVE MATERIAL PARTICLE, BATTERY, AND METHOD FOR MANUFACTURING COMPOSITE ACTIVE MATERIAL PARTICLE

(71) Applicant: Panasonic Intellectual Property Management Co., Ltd., Osaka (JP)

(72) Inventors: KUNIHIKO MINEYA, Osaka (JP); TADAAKI MATSUMURA, Shiga (JP)

(21) Appl. No.: 18/905,124

(22) Filed: Oct. 2, 2024

Related U.S. Application Data
(63) Continuation of application No. PCT/JP2022/041393, filed on Nov. 7, 2022.

(30) Foreign Application Priority Data
Apr. 13, 2022 (JP) 2022-066483

(51) Int. Cl. H01M 4/485; H01M 4/02; H01M 4/04; H01M 10/0562

(52) U.S. Cl. CPC H01M 4/485; H01M 4/0407; H01M 10/0562; H01M 2004/027; H01M 2300/0077

(57) ABSTRACT

A composite active material particle includes an oxide phase containing an oxide, multiple active material domains containing an active material and dispersed in the oxide phase, and at least one first solid electrolyte having a composition different from the composition of the oxide. The first solid electrolyte covers at least part of the surface of a base particle composed of the oxide phase and the multiple active material domains.

### BACKGROUND

### 1. Technical Field

The present disclosure relates to a composite active material particle, a battery, and a method for manufacturing a composite active material particle.

### 2. Description of the Related Art

With the rapid proliferation of electrical products such as personal computers, video cameras, and mobile phones, greater importance is being placed on the development of batteries as power supplies. In the automotive industry, furthermore, the development of high-power and high-capacity lithium batteries is ongoing for electric or hybrid vehicles. Alloy materials that alloy with lithium are expected as negative electrode active materials for high-capacity lithium batteries. A typical example of an alloy material is silicon.

In Japanese Patent No. 6786474, a negative electrode active material including a lithium silicate phase and silicon particles dispersed in the lithium silicate phase is described.

### SUMMARY

In the related art, there is a need for a technology for reducing a decrease in the charging efficiency of a battery made with composite active material particles.

In one general aspect, the techniques disclosed here feature a composite active material particle including an oxide phase containing an oxide, multiple active material domains containing an active material and dispersed in the oxide phase, and at least one first solid electrolyte having a composition different from a composition of the oxide, wherein the first solid electrolyte covers at least part of a surface of a base particle composed of the oxide phase and the multiple active material domains.

According to an aspect of the present disclosure, there can be provided a technology for reducing a decrease in the charging efficiency of a battery made with composite active material particles.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view illustrating a schematic structure of a composite active material particle in Embodiment 1;

FIG. 2 is a cross-sectional view illustrating a schematic structure of a base particle used in a method for manufacturing a composite active material particle in Embodiment 1;

FIG. 3 is a flowchart illustrating an example of a method for manufacturing a composite active material particle in Embodiment 1;

FIG. 4 is a cross-sectional view illustrating a schematic structure of a battery in Embodiment 2; and

FIG. 5 is a cross-sectional view illustrating a detailed structure of a negative electrode and a negative electrode active material layer.

### DETAILED DESCRIPTIONS

### Underlying Knowledge Forming Basis of the Present Disclosure

Japanese Patent No. 6786474 discloses that the cycle characteristics of the battery improves as a result of the lithium silicate phase absorbing the expansion and contraction of the silicon particles associated with charging and discharging.

For negative electrode active materials obtained by dispersing silicon particles in a lithium silicate phase like that described in Japanese Patent No. 6786474, numerous silicon particles are present in an exposed state on the outer surface of the negative electrode active material. When numerous silicon particles are exposed on the outer surface of the negative electrode active material, it is likely that the interfacial contact between the negative electrode active material and a solid electrolyte is poor. In other words, separation between the negative electrode active material and the solid electrolyte can occur because of the expansion and contraction of the silicon particles exposed on the outer surface of the negative electrode active material during charging and discharging of the battery. The separation between the negative electrode active material and the solid electrolyte is likely to occur particularly during high-rate charging, during which the speed of expansion of the silicon particles is great. Once the negative electrode active material and the solid electrolyte become separate from each other, the charging efficiency of the battery decreases.

The present disclosure was made in light of these actualities, and an aspect thereof provides a technique for reducing a decrease in the charging efficiency of a battery made with composite active material particles.

### Overview of Aspects of the Present Disclosure

A composite active material particle according to a first aspect of the present disclosure includes:
an oxide phase containing an oxide;
multiple active material domains containing an active material and dispersed in the oxide phase; and
at least one first solid electrolyte having a composition different from a composition of the oxide, wherein:
the first solid electrolyte covers at least part of a surface of a base particle composed of the oxide phase and the multiple active material domains.

With the composite active material particle according to an aspect of the present disclosure, a decrease in the charging efficiency of a battery can be reduced.

In a second aspect of the present disclosure, the composite active material particle according to the first aspect may be one in which, for example, the first solid electrolyte has a garnet-type crystal structure. Solid electrolytes having a garnet-type crystal structure have high lithium-ion conductivity and are electrically stable even in a reducing atmosphere at a negative electrode at the same time.

In a third aspect of the present disclosure, the composite active material particle according to the first or second aspect may be one in which, for example, the first solid electrolyte includes at least one selected from the group consisting of Li₇La₃Zr₂O₁₂, Li₇₋₃ₓLa₃Zr₂AlₓO₁₂, where 0≤x<0.3, Li_{7-y}La₃Zr_{2-y}Nb_{y}O₁₂, where 0≤y<0.3, and Li_{7-z}La₃Zr_{2-z}Ta_{z}O₁₂, where 0≤z<0.5. Such solid electrolytes have high lithium-ion conductivity and are electrically stable even in a reducing atmosphere at a negative electrode at the same time.

In a fourth aspect of the present disclosure, the composite active material particle according to any one of the first to third aspects may be one in which, for example, the active material includes a material that forms an alloy with lithium. The composite active material particle according to an aspect of the present disclosure is particularly useful when the active material includes a material that forms an alloy with lithium.

In a fifth aspect of the present disclosure, the composite active material particle according to any one of the first to fourth aspects may be one in which, for example, the active material includes at least one selected from the group consisting of elemental silicon and SiOₐ, where 0<a<2. The composite active material particle according to an aspect of the present disclosure is particularly useful when the active material particle contains at least one selected from the group consisting of elemental silicon and SiOₐ, where 0<a<2.

In a sixth aspect of the present disclosure, the composite active material particle according to any one of the first to fifth aspects may be one in which, for example, the oxide phase is amorphous. The composite active material particle according to an aspect of the present disclosure is particularly useful when the oxide phase is amorphous.

In a seventh aspect of the present disclosure, the composite active material particle according to any one of the first to sixth aspects may be one in which, for example, the oxide phase contains a lithium silicate. The composite active material particle according to an aspect of the present disclosure is particularly useful when the oxide phase contains a lithium silicate.

In an eighth aspect of the present disclosure, the composite active material particle according to the seventh aspect may be one in which, for example, the lithium silicate has a composition represented by Li_{2b}SiO_{(2+b)}, where 0<b≤2. With this configuration, the expansion and contraction of the active material can be absorbed significantly.

A battery according to a ninth aspect of the present disclosure includes:
a positive electrode;
a negative electrode; and
an electrolyte layer located between the positive electrode and the negative electrode, wherein:
the negative electrode contains the composite active material particle according to any one of the first to eighth aspects.

With the battery according to an aspect of the present disclosure, a decrease in the charging efficiency of a battery can be reduced.

In a tenth aspect of the present disclosure, the battery according to the ninth aspect may be one in which, for example, the negative electrode further contains at least one second solid electrolyte having a composition different from the compositions of the oxide and the first solid electrolyte. The composite active material particle according to an aspect of the present disclosure is particularly useful when the negative electrode contains a solid electrolyte.

In an eleventh aspect of the present disclosure, the battery according to the tenth aspect may be one in which, for example, the second solid electrolyte includes a sulfide solid electrolyte. With this configuration, the charging efficiency of a battery can be improved.

In a twelfth aspect of the present disclosure, the battery according to any one of the eighth to eleventh aspects may be one in which, for example, the electrolyte layer contains at least one third solid electrolyte. With this configuration, the charging efficiency of a battery can be improved.

A method according to a thirteenth aspect of the present disclosure for manufacturing a composite active material particle includes:

coating at least part of a surface of a base particle, the base particle having a structure in which multiple active material domains containing an active material are dispersed in an oxide phase, with at least one first solid electrolyte.

With the method according to an aspect of the present disclosure for manufacturing a composite active material particle, composite active material particles having a structure suitable for the reduction of a decrease in the charging efficiency of a battery can be manufactured.

In a fourteenth aspect of the present disclosure, the method according to the thirteenth aspect for manufacturing a composite active material particle may be one in which, for example, the at least part of the surface of the base particle is coated with the at least one first solid electrolyte by a solid-phase process. With this configuration, composite active material particles having a structure suitable for the reduction of a decrease in the charging efficiency of a battery can be manufactured more simply.

Embodiments of the present disclosure will now be described with reference to drawings.

### Embodiment 1

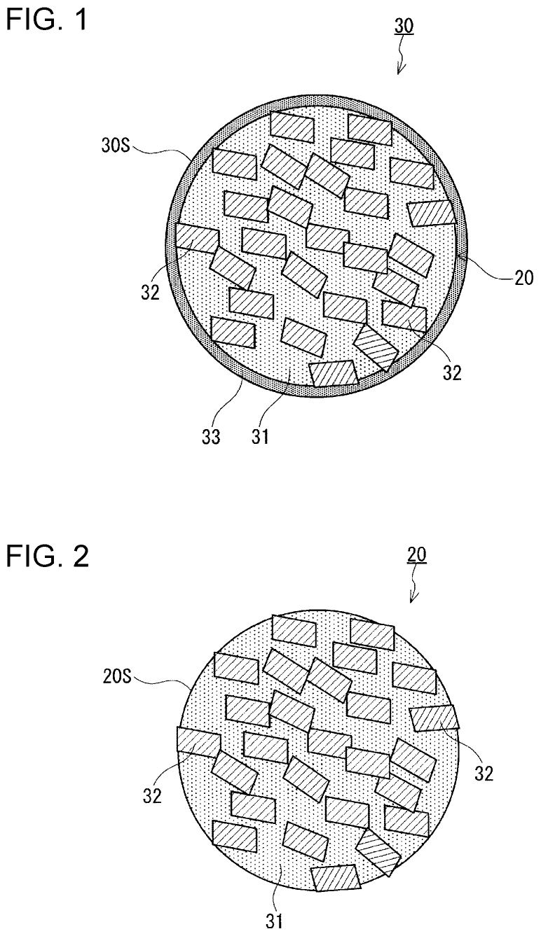

FIG. 1 is a cross-sectional view illustrating a schematic structure of a composite active material particle 30 in Embodiment 1. The composite active material particle 30 includes an oxide phase 31, multiple active material domains 32, and at least one first solid electrolyte 33. The oxide phase 31 contains an oxide. The active material domains 32 contain at least one active material. The first solid electrolyte 33 has a composition different from that of the oxide contained in the oxide phase 31. The multiple active material domains 32 are dispersed in the oxide phase 31. The first solid electrolyte 33 covers at least part of the surface 20S of a base particle 20 composed of the oxide phase 31 and the multiple active material domains 32.

For the composite active material particle 30 in this embodiment, multiple active material domains 32 are dispersed in an oxide phase 31, and, at the same time, at least one first solid electrolyte 33 covers at least part of the surface 20S of a base particle 20 composed of the oxide phase 31 and the multiple active material domains 32. For the composite active material particle 30, therefore, the amount of active material present in an exposed state on the outer surface 30S of the composite active material particle 30 is restricted by the first solid electrolyte 33. By virtue of this, even when the active material expands and contracts during charging and discharging of the battery, therefore, the separation between composite active material particles 30 and the second solid electrolyte, which will be described later herein, is limited in the negative electrode active material layer, ensuring that good interfacial contact will be maintained. As a result, a decrease in the charging efficiency of the battery is reduced.

The first solid electrolyte 33 may include an oxide solid electrolyte. Oxide solid electrolytes have a high degree of lithium-ion conductivity of approximately 10⁻⁴ Scm⁻¹ in 25° C. environments and are electrically stable even in a reducing atmosphere at a negative electrode at the same time. The first solid electrolyte 33 may be an oxide solid electrolyte.

As the oxide solid electrolyte, substances such as NASICON solid electrolytes, typified by LiTi₂(PO₄)₃ and its substituted derivatives, (LaLi)TiO₃-based perovskite solid electrolytes, LISICON solid electrolytes, typified by Li₁₄ZnGe₄O₁₆, Li₄SiO₄, LiGeO₄, and their substituted derivatives, garnet solid electrolytes, typified by Li₇La₃Zr₂O₁₂ and its substituted derivatives, Li₃N and its H-substituted derivatives, Li₃PO₄ and its N-substituted derivatives, and glass or glass-ceramics in which a base material containing a Li—B—O compound, such as LiBO₂ or Li₃BO₃, has been doped with a material such as Li₂SO₄ or Li₂CO₃ can be used.

The first solid electrolyte 33 may have a garnet-type crystal structure. In other words, the first solid electrolyte 33 may be a garnet solid electrolyte. The first solid electrolyte 33 may be a garnet solid electrolyte that belongs to the cubic crystal system. Solid electrolytes having a garnet-type crystal structure have high lithium-ion conductivity and are electrically stable even in a reducing atmosphere at a negative electrode at the same time. Among others, garnet solid electrolytes that belong to the cubic crystal system have high lithium-ion conductivity.

Examples of solid electrolytes having a garnet-type crystal structure include Li₇La₃Zr₂O₁₂, Li₇₋₃ₓLa₃Zr₂AlₓO₁₂ (0≤x<0.3), Li_{7-y}La₃Zr_{2-y}Nb_{y}O₁₂ (0≤y<0.3), and Li_{7-z}La₃Zr_{2-z}Ta₂O₁₂ (0≤z<0.5). The first solid electrolyte 33 may include at least one selected from these. The first solid electrolyte 33 may be Li₇₋₃ₓLa₃Zr₂AlₓO₁₂ (0≤x<0.3). Such first solid electrolytes 33 have a high degree of lithium-ion conductivity of 10⁻⁴ Scm⁻¹ in 25° C. environments and are electrically stable even in a reducing atmosphere at a negative electrode at the same time.

The first solid electrolyte 33 may include a sulfide solid electrolyte. Sulfide solid electrolytes have a high degree of lithium-ion conductivity of 10⁻⁴ Scm⁻¹ in 25° C. environments and are electrically stable even in a reducing atmosphere at a negative electrode at the same time. The first solid electrolyte 33 may be a sulfide solid electrolyte.

As the sulfide solid electrolyte, substances such as Li₂S—P₂S₅, Li₂S—SiS₂, Li₂SB₂S₃, Li₂S—GeS₂, Li_{3.25}Ge_{0.25}P_{0.75}S₄, and Li₁₀GeP₂S₁₂ can be used. These may be doped with, for example, LiX, Li₂O, MO_{q}, or LiₚMO_{q}. In this context, element X in “LiX” is at least one selected from the group consisting of F, Cl, Br, and I. Element M in “MO_{q}” and “LiₚMO_{q}” is at least one selected from the group consisting of P, Si, Ge, B, Al, Ga, In, Fe, and Zn. p and q in “MO_{q}” and “LiₚMO_{q}” are natural numbers independent of each other.

The base particle 20 may be a primary particle or may be a secondary particle. The oxide phase 31 may be a continuous phase having no definite grain boundary.

The first solid electrolyte 33 may uniformly cover the surface 20S of the base particle 20. In other words, the outer surface 30S of the composite active material particle 30 may be formed by the first solid electrolyte 33. With this configuration, the amount of active material present in an exposed state on the outer surface 30S of the composite active material particle 30 is further reduced by the first solid electrolyte 33. Even when the active material expands and contracts during charging and discharging of the battery, therefore, the separation between composite active material particles 30 and the second solid electrolyte, which will be described later herein, is further limited in the negative electrode active material layer, allowing better interfacial contact to be maintained.

The first solid electrolyte 33 may cover only part of the surface 20S of the base particle 20. In other words, part of the outer surface 30S of the composite active material particle 30 may be formed by the first solid electrolyte 33.

The thickness of the first solid electrolyte 33, covering at least part of the surface 20S of the base particle 20, may be uniform or may be nonuniform.

The average thickness of the first solid electrolyte 33 may be greater than or equal to 10 nm and less than or equal to 500 nm. With this configuration, the total amount of solid electrolyte in relation to the entire negative electrode can be kept moderate. Through this, a decrease in the weight energy density of the negative electrode can be reduced.

The average thickness of the first solid electrolyte 33 can be determined by, for example, the following method. Specifically, first, the composite active material particle 30 is processed to expose a cross-section. The processing of the composite active material particle 30 can be performed using, for example, CROSS SECTION POLISHER®. With CROSS SECTION POLISHER, a smooth cross-section can be created through the composite active material particle 30. Then the cross-section of the composite active material particle 30 is observed using a scanning electron microscope (SEM) or transmission electron microscope (TEM). This gives an SEM image or TEM image of the cross-section of the composite active material particle 30. Then, on the SEM image or TEM image obtained, the base particle 20 and the first solid electrolyte 33 are identified. The identification of them may be performed based on the contrast of the image or may be performed based on the results of elemental analysis, such as energy dispersive x-ray analysis (EDS). Then, on the SEM image or TEM image, the thickness of the first solid electrolyte 33 at ten randomly selected points is measured. By averaging the measured values, the average thickness of the first solid electrolyte 33 can be determined.

In the base particle 20, the ratio of the mass M2 of the oxide phase 31 to the mass M1 of the active material contained in the multiple active material domains 32 (M2/M1=silicate/silicon) may be such that 0.5≤M2/M1≤1. By appropriately adjusting the ratio (M2/M1), the expansion and contraction of the active material can be significantly absorbed with the oxide phase 31.

The ratio of the mass M4 of the first solid electrolyte 33 to the mass M3 of the composite active material particle 30 (M4/M3) may be such that 0.1≤M4/M3≤0.3. By appropriately adjusting the ratio (M4/M3), the expansion and contraction of the active material can be significantly mitigated with the first solid electrolyte 33.

When a cross-section of the composite active material particle 30 is observed, the area occupied by the base particle 20 may be larger than the area occupied by the first solid electrolyte 33. For example, when the oxide phase 31 is a lithium silicate phase, the lithium silicate contained in the lithium silicate phase has no electronic conductivity. When the area occupied by the base particle 20 is larger than the area occupied by the first solid electrolyte 33, however, sufficient electronic conductivity can be ensured with the active material contained in the base particle 20.

The active material domains 32 contain at least one active material having the ability to store and release metal ions. The active material contained in the active material domains 32 may include a material that forms an alloy with lithium. Examples of such materials include elemental metals that form an alloy with lithium and compounds containing a metal that forms an alloy with lithium. Examples of elemental metals include silicon, tin, germanium, and bismuth. Examples of compounds containing a metal that forms an alloy with lithium include oxides, carbides, nitrides, silicides, sulfides, and phosphides.

The active material domains 32 may contain, as the active material, at least one selected from the group consisting of elemental silicon and SiOₐ (0<a<2). The composite active material particle 30 in this embodiment is particularly useful when the active material includes at least one selected from the group consisting of elemental silicon and SiOₐ (0<a<2). The active material may be elemental silicon.

The active material domains 32 may be particles made of elemental silicon. In that case, the purity of the silicon in the silicon particles is not particularly limited; for example, the purity is greater than or equal to 99% (2N). The silicon particles may be single-crystal silicon particles or may be polycrystalline silicon particles.

The size of the active material domains 32 is not particularly limited. The active material domains 32 may have a size on the order of nanometers. The average particle size of the active material domains 32 is, for example, greater than or equal to 0.01 μm and less than or equal to 3 μm. The average particle size of the active material domains 32 can be calculated by, for example, the following method. For example, a cross-section of the composite active material particle 30 is observed with an electron microscope (SEM or TEM), and the area of a particular active material domain 32 in the SEM image or TEM image is calculated through image processing. The diameter of a circle having an area equal to the calculated area is considered the diameter of the particular active material domain 32. The diameter of any number (e.g., ten) of active material domains 32 is calculated, and the average is considered the average particle size of the active material domains 32.

The active material domains 32 may include domains of the active material having a shape that can hardly be described as a particle. In FIG. 1, the active material domains 32 are generally equal in size. However, there may be relatively large active material domains 32, for example, formed through the coalescence of several active material particles. In certain instances, the active material domains 32 and the oxide phase 31 may present a patchy pattern. The shape of the active material domains 32 is not particularly limited either. For example, the active material domains 32 have a shape such as spherical, ellipsoidal, or flakes.

The oxide phase 31 may be free of elemental silicon and SiOₐ (0<a<2). The composite active material particle 30 in this embodiment is particularly useful when the oxide phase 31 is free of elemental silicon and SiOₐ (0<a<2).

The oxide phase 31 may be amorphous. As used herein, “amorphous” means that the degree of crystallinity is substantially 0% (specifically, less than 0.1%) and that only an amorphous halo is observed in an x-ray diffraction spectrum, with no crystalline peak observed.

The oxide phase 31 may contain at least one lithium silicate. The composite active material particle 30 in this embodiment is particularly useful when the oxide phase 31 contains at least one lithium silicate. This is because the lithium silicate has lithium-ion conductivity and does not expand during charging of the battery. The oxide phase 31 may be a lithium silicate phase.

The lithium silicate can have a composition represented by Li_{2b}SiO_{(2+b)} (0<b≤2). When the oxide phase 31 is a lithium silicate phase, the multiple active material domains 32 are encapsulated in the oxide phase 31, which is a lithium silicate phase. By a lithium silicate having such a composition, the expansion and contraction of the active material domains 32 can be significantly absorbed. Examples of specific compositions for crystalline lithium silicates include Li₄SiO₄(b=2), Li₂SiO₃ (b=1), and Li₂Si₂O₅ (b=½). The lithium silicate phase may contain a lithium silicate with a single composition or lithium silicates with multiple compositions. The lithium silicate may be amorphous. In the case of an amorphous lithium silicate, the “b” can be a value other than ½, 1, or 2 as a result of the complexation of lithium silicates with multiple compositions.

Examples of lithium silicates include Li₄SiO₄, Li₂SiO₃, and Li₂Si₂O₅. The lithium silicate may include at least one selected from the group consisting of Li₄SiO₄, Li₂SiO₃, and Li₂Si₂O₅. The lithium silicate may include Li₂SiO₃. The lithium silicate may be Li₂SiO₃.

Composite active material particles 30 have an average particle size in the range of, for example, 0.1 μm to 30 μm. The average particle size of composite active material particles 30 can also be measured by the same method as the method for measuring the average particle size of the active material domains 32. When the average particle size of composite active material particles 30 is appropriately adjusted, the composite active material particles 30 and the second solid electrolyte, which will be described later herein, can form a good dispersion state in the negative electrode. By virtue of this, the charge-discharge characteristics of the battery improve. Lithium diffusion inside the composite active material particles 30, furthermore, becomes faster. As a result, the battery can operate at high power.

The percentage of the mass of the active material domains 32 to the mass of the composite active material particle 30 is, for example, greater than or equal to 30% and less than or equal to 70%.

A method for manufacturing a composite active material particle 30 will be described.

The method for manufacturing a composite active material particle 30 includes coating at least part of the surface 20S of a base particle 20, the base particle 20 having a structure in which multiple active material domains 32 containing an active material are dispersed in an oxide phase 31, with at least one first solid electrolyte 33.

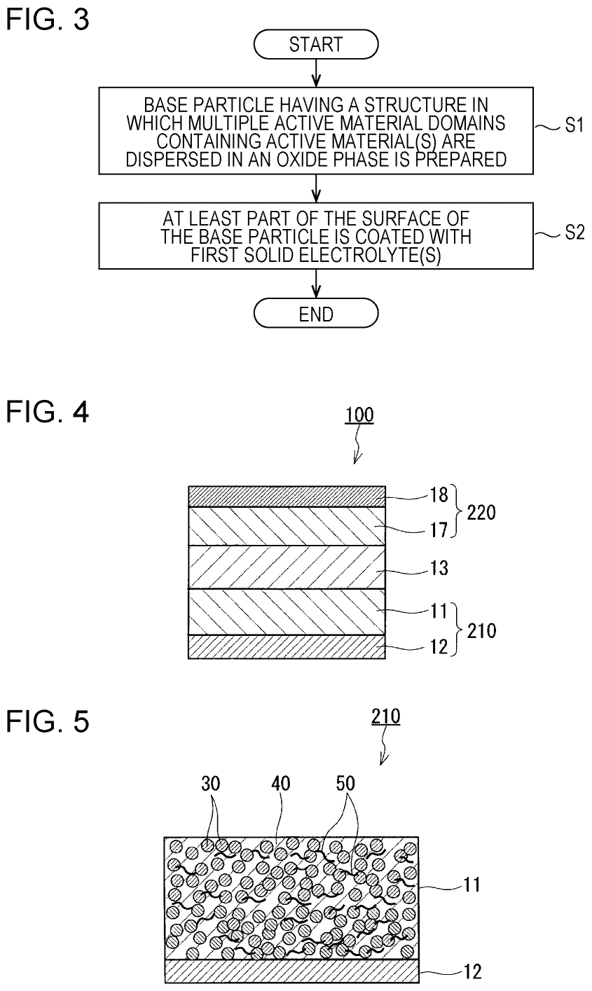

FIG. 3 is a flowchart illustrating an example of a method for manufacturing a composite active material particle 30. The composite active material particle 30 may be produced through each step illustrated in the flowchart.

First, a base particle 20 having a structure in which multiple active material domains 32 containing an active material are dispersed in an oxide phase 31 is prepared (step S1). FIG. 2 is a cross-sectional view illustrating a schematic structure of the base particle 20. For example, silicon particles are used as the material for the active material domains 32, and a lithium silicate is used as the material for the oxide phase 31. In this case, step S1 is performed as follows. First, a silicon powder and a lithium silicate powder are prepared. These are mixed in a predetermined ratio to give a feedstock powder. The feedstock powder is processed by a method such as mechanical alloying. This gives base particles 20. By processing the base particles 20 using a mesh or sieve with a predetermined mesh size, a powder of base particles 20 having a desired average particle size is obtained.

Then at least part of the surface 20S of the base particle 20 is coated with at least one first solid electrolyte 33 (step S2). In step S2, a powder of the first solid electrolyte 33 is prepared first. The method for coating at least part of the surface 20S of the base particle 20 with the first solid electrolyte 33 is not particularly limited. It may be coated by any of a liquid-phase process, vapor-phase process, or solid-phase process. A solid-phase process is suitable for use because of the ease of handling. Examples of solid-phase processes include solid-phase reaction. Examples of liquid-phase processes include coprecipitation, the sol-gel method, and hydrothermal reaction. Examples of vapor-phase processes include sputtering and CVD.

### Embodiment 2

FIG. 4 is a cross-sectional view illustrating a schematic structure of a battery 100 in Embodiment 2. The battery 100 includes a positive electrode 220, a negative electrode 210, and an electrolyte layer 13. The electrolyte layer 13 is located between the positive electrode 220 and the negative electrode 210.

The positive electrode 220 has a positive electrode active material layer 17 and a positive electrode current collector 18. The positive electrode active material layer 17 is disposed between the electrolyte layer 13 and the positive electrode current collector 18. The positive electrode active material layer 17 is in electrical contact with the positive electrode current collector 18.

The positive electrode current collector 18 is a component having the function of collecting electricity from the positive electrode active material layer 17. Examples of materials for the positive electrode current collector 18 include aluminum, an aluminum alloy, stainless steel, copper, and nickel. The positive electrode current collector 18 may be made of aluminum or an aluminum alloy. The dimensions, shape, and other characteristics of the positive electrode current collector 18 can be selected as appropriate according to the purpose of use of the battery 100.

The positive electrode active material layer 17 contains a positive electrode active material and at least one solid electrolyte. As the positive electrode active material, a material having the ability to store and release metal ions, such as lithium ions, can be used. As the positive electrode active material, materials such as lithium-containing transition metal oxides, transition metal fluorides, polyanionic materials, fluorinated polyanionic materials, transition metal sulfides, transition metal oxysulfides, and transition metal oxynitrides can be used. Examples of lithium-containing transition metal oxides are Li(Ni,Co,Al)O₂, Li(Ni,Co,Mn)O₂, and LiCoO₂. When a lithium-containing transition metal oxide, in particular, is used as the positive electrode active material, the manufacturing costs can be reduced, and the average discharge voltage can be increased.

As used herein, the notation “(A,B,C)” in a chemical formula represents “at least one selected from the group consisting of A, B, and C.” For example, “(Ni,Co,Al)” is synonymous with “at least one selected from the group consisting of Ni, Co, and Al.” The same also applies when other elements are used.

The positive electrode active material has, for example, a shape of particles. The shape of the particles of the positive electrode active material is not particularly limited. The shape of the particles of the positive electrode active material can be needle-like, spherical, ellipsoidal, or flakes.

The median diameter of the particles of the positive electrode active material may be greater than or equal to 0.1 μm and less than or equal to 100 μm. When the median diameter of the particles of the positive electrode active material is greater than or equal to 0.1 μm, the positive electrode active material and the solid electrolyte can form a good dispersion state in the positive electrode 220. As a result of this, the charge-discharge characteristics of the battery 100 improve. When the median diameter of the particles of the positive electrode active material is less than or equal to 100 μm, lithium diffusion inside the particles of the positive electrode active material becomes faster. The battery 100, therefore, can operate at high power.

As the solid electrolyte in the positive electrode 220, at least one selected from the group consisting of a sulfide solid electrolyte, an oxide solid electrolyte, a halide solid electrolyte, a polymeric solid electrolyte, and a complex hydride solid electrolyte may be used. Oxide solid electrolytes have excellent high-potential stability. By using an oxide solid electrolyte, the charging efficiency of the battery 100 can be further improved.

For the positive electrode 220, it may be that 30≤v1≤95 regarding the ratio by volume “v1:100−v1” between the positive electrode active material and the solid electrolyte. When 30≤v1, a sufficient energy density of the battery 100 is ensured. When v1≤95, furthermore, high-power operation of the battery 100 is enabled.

The thickness of the positive electrode 220 may be greater than or equal to 10 μm and less than or equal to 500 μm. When the thickness of the positive electrode 220 is greater than or equal to 10 μm, a sufficient energy density of the battery 100 is ensured. When the thickness of the positive electrode 220 is less than or equal to 500 μm, high-power operation of the battery 100 is enabled.

The shape of the solid electrolyte contained in the positive electrode 220 is not particularly limited. The shape of the solid electrolyte may be, for example, needle-like, spherical, or ellipsoidal. For example, the shape of the solid electrolyte may be particulate.

When the shape of the solid electrolyte contained in the positive electrode 220 is particulate (e.g., spherical), the median diameter of the particles of the solid electrolyte may be less than or equal to 100 μm. When the median diameter is less than or equal to 100 μm, the positive electrode active material and the solid electrolyte can form a good dispersion state in the positive electrode 220. By virtue of this, the charge-discharge characteristics of the battery 100 improve.

As used herein, “median diameter” refers to the particle diameter in a volume-based particle size distribution when the cumulative volume is equal to 50%. The volume-based particle size distribution is measured using, for example, a laser diffraction analyzer or an image analyzer.

The positive electrode active material layer 17 may contain a conductive additive for the purpose of enhancing electronic conductivity. As the conductive additive, materials such as the graphite of natural graphite or artificial graphite, carbon blacks, such as acetylene black and Ketjenblack, electrically conductive fibers, such as carbon fibers or metallic fibers, metal powders, for example of fluorocarbon and aluminum, electrically conductive whiskers, for example of zinc oxide or potassium titanate, electrically conductive metal oxides, such as titanium oxide, and electrically conductive polymeric compounds, such as polyaniline, polypyrrole, and polythiophene, can be used. When a carbon conductive additive is used, cost reduction can be attempted.

The electrolyte layer 13 is located between the positive electrode 220 and the negative electrode 210. The electrolyte layer 13 is a layer containing at least one electrolyte. The electrolyte is, for example, a solid electrolyte having lithium-ion conductivity. The electrolyte layer 13 can be a solid electrolyte layer. The solid electrolyte contained in the electrolyte layer 13 is hereinafter referred to as the third solid electrolyte.

The electrolyte layer 13 may contain, as the third solid electrolyte, at least one selected from the group consisting of a halide solid electrolyte, a sulfide solid electrolyte, an oxide solid electrolyte, a polymeric solid electrolyte, and a complex hydride solid electrolyte.

The electrolyte layer 13 may have a multilayer structure. In that case, the composition of the material for the layer in contact with the negative electrode 210 may be different from the composition of the material for the layer in contact with the positive electrode 220. The layer in contact with the negative electrode 210 may be made of a sulfide solid electrolyte, which is superior in reduction resistance. The layer in contact with the positive electrode 220 may be made of a halide solid electrolyte, which is superior in oxidation resistance.

The shape of the third solid electrolyte, contained in the electrolyte layer 13, is not particularly limited. The shape of the third solid electrolyte may be, for example, needle-like, spherical, or ellipsoidal. For example, the shape of the third solid electrolyte may be particulate.

When the shape of the third solid electrolyte, contained in the electrolyte layer 13, is particulate (e.g., spherical), the median diameter of the particles of the third solid electrolyte may be less than or equal to 100 μm. When the median diameter is less than or equal to 100 μm, the third solid electrolyte can form a good dispersion state in the electrolyte layer 13. By virtue of this, the charge-discharge characteristics of the battery 100 improve.

The thickness of the electrolyte layer 13 may be greater than or equal to 1 μm and less than or equal to 300 μm. When the thickness of the electrolyte layer 13 is greater than or equal to 1 μm, short-circuiting between the positive electrode 220 and the negative electrode 210 can be reliably prevented. When the thickness of the electrolyte layer 13 is less than or equal to 300 μm, the battery 100 can achieve high-power operation.

The negative electrode 210 includes a negative electrode active material layer 11 and a negative electrode current collector 12. The negative electrode active material layer 11 is disposed between the electrolyte layer 13 and the negative electrode current collector 12. The negative electrode active material layer 11 is in electrical contact with the negative electrode current collector 12.

The negative electrode current collector 12 is a component having the function of collecting electricity from the negative electrode active material layer 11. Examples of materials for the negative electrode current collector 12 include aluminum, an aluminum alloy, stainless steel, copper, and nickel. The negative electrode current collector 12 may be made of nickel. The dimensions, shape, and other characteristics of the negative electrode current collector 12 can be selected as appropriate according to the purpose of use of the battery 100.

FIG. 5 is a cross-sectional view illustrating a detailed structure of the negative electrode 210 and the negative electrode active material layer 11. The negative electrode active material layer 11 contains composite active material particles 30 in Embodiment 1 as a negative electrode active material.

The negative electrode active material layer 11 may further contain at least one second solid electrolyte 40. The second solid electrolyte 40 may have a composition different from those of the oxide contained in the oxide phase 31 and the first solid electrolyte 33 of the composite active material particles 30 in Embodiment 1. As the second solid electrolyte 40, at least one selected from the group consisting of a sulfide solid electrolyte, an oxide solid electrolyte, a halide solid electrolyte, a polymeric solid electrolyte, and a complex hydride solid electrolyte can be used. The second solid electrolyte 40 may be a sulfide solid electrolyte.

When the negative electrode active material layer 11 contains the second solid electrolyte 40, or, in other words, when the battery 100 is a solid-state battery, using silicon particles as the active material contained in the active material domains 32 of the composite active material particles 30 leads to limited space for the expansion and contraction of the silicon particles. From the viewpoint of charging efficiency, therefore, it is not easy to use silicon particles by directly dispersing them in the negative electrode active material layer 11. For this reason, the composite active material particle 30 in Embodiment 1 is particularly useful when the negative electrode active material layer 11 contains the second solid electrolyte 40.

As the sulfide solid electrolyte, the sulfide solid electrolytes mentioned in the context of the first solid electrolyte 33 in Embodiment 1 can be used.

As the oxide solid electrolyte, the oxide solid electrolytes mentioned in the context of the first solid electrolyte 33 in Embodiment 1 can be used.

As the polymeric solid electrolyte, a compound of a polymeric compound and at least one lithium salt, for example, can be used. The polymeric compound may have an ethylene oxide structure. When having an ethylene oxide structure, the polymeric compound can contain more of the lithium salt, thereby helping further increase ionic conductivity. As the lithium salt, compounds such as LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃ can be used. One lithium salt selected from these may be used alone as the lithium salt, or a mixture of two or more lithium salts selected from these may be used.

As the complex hydride solid electrolyte, substances such as LiBH₄—LiI and LiBH₄—P₂S₅ can be used.

The halide solid electrolyte is represented by, for example, formula (1) below. In formula (1), each of α, β, and γ is independently a value greater than 0. M includes at least one selected from the group consisting of metal elements other than Li and metalloid elements. X includes at least one selected from the group consisting of F, Cl, Br, and I.

Li₆₀ M_{β}X_{γ} Formula (1)

The metalloid elements include B, Si, Ge, As, Sb, and Te. The metal elements include all elements included in groups 1 to 12 of the periodic table excluding hydrogen and all elements included in groups 13 to 16 excluding B, Si, Ge, As, Sb, Te, C, N, P, O, S, and Se. The metal elements are a group of elements that can become cations when forming an inorganic compound with a halogen compound.

As the halide solid electrolyte, substances such as Li₃YX₆, Li₂MgX₄, Li₂FeX₄, Li(Al,Ga,In)X₄, and Li₃(Al,Ga,In)X₆ can be used. Halide solid electrolytes exhibit excellent ionic conductivity.

Each of the solid electrolytes described above can be used not only in the negative electrode 210, but also as the solid electrolyte in the positive electrode 220 and as the third solid electrolyte, in the electrolyte layer 13, both described above.

When the ratio by volume between the composite active material particles 30 and the second solid electrolyte 40 in the negative electrode 210 is represented by “v2:100−v2,” the percentage by volume v2 of the composite active material particles 30 may be such that 30≤v2≤95. When 30≤v2, a sufficient energy density of the battery 100 is ensured. When v2≤95, furthermore, high-power operation of the battery 100 is enabled.

The shape of the second solid electrolyte 40, contained in the negative electrode 210, is not particularly limited. The shape of the second solid electrolyte 40 may be, for example, needle-like, spherical, or ellipsoidal. For example, the shape of the second solid electrolyte 40 may be particulate.

When the shape of the second solid electrolyte 40, contained in the negative electrode 210, is particulate (e.g., spherical), the median diameter of the particles of the second solid electrolyte 40 may be less than or equal to 100 μm. When the median diameter is less than or equal to 100 μm, the composite active material particles 30 and the second solid electrolyte 40 can form a good dispersion state in the negative electrode 210. By virtue of this, the charge-discharge characteristics of the battery 100 improve.

The median diameter of the particles of the second solid electrolyte 40 may be smaller than the median diameter of the composite active material particles 30. This allows the composite active material particles 30 and the second solid electrolyte 40 to form a good dispersion state.

The thickness of the negative electrode 210 may be greater than or equal to 10 μm and less than or equal to 500 μm. When the thickness of the negative electrode 210 is greater than or equal to 10 μm, a sufficient energy density of the battery 100 is ensured. When the thickness of the negative electrode 210 is less than or equal to 500 μm, high-power operation of the battery 100 is enabled.

The negative electrode active material layer 11 may contain a conductive additive 50 for the purpose of enhancing electronic conductivity. As the conductive additive 50, the materials listed as conductive additives 50 that may be contained in the positive electrode active material layer 17 can be used.

In at least one selected from the group consisting of the positive electrode active material layer 17, the electrolyte layer 13, and the negative electrode active material layer 11, at least one selected from the group consisting of a sulfide solid electrolyte, an oxide solid electrolyte, a polymeric solid electrolyte, and a complex hydride solid electrolyte may be contained for the purpose of facilitating the exchange of lithium ions and improving the power characteristics of the battery 100. As the sulfide solid electrolyte, oxide solid electrolyte, halide solid electrolyte, polymeric solid electrolyte, and complex hydride solid electrolyte, the sulfide solid electrolytes, oxide solid electrolytes, halide solid electrolytes, polymeric solid electrolytes, and complex hydride solid electrolytes mentioned as the second solid electrolyte 40, in the negative electrode 210, can be used.

In at least one selected from the group consisting of the positive electrode active material layer 17, the electrolyte layer 13, and the negative electrode active material layer 11, a nonaqueous electrolyte solution, gel electrolyte, or ionic liquid may be contained for the purpose of facilitating the exchange of lithium ions and improving the power characteristics of the battery.

The nonaqueous electrolyte solution contains at least one nonaqueous solvent and at least one lithium salt dissolved in the nonaqueous solvent. Examples of nonaqueous solvents include cyclic carbonate solvents, linear carbonate solvents, cyclic ether solvents, linear ether solvents, cyclic ester solvents, linear ester solvents, and fluorinated solvents. Examples of cyclic carbonate solvents include ethylene carbonate, propylene carbonate, and butylene carbonate. Examples of linear carbonate solvents include dimethyl carbonate, ethyl methyl carbonate, and diethyl carbonate. Examples of cyclic ether solvents include tetrahydrofuran, 1,4-dioxane, and 1,3-dioxolane. Examples of linear ether solvents include 1,2-dimethoxyethane and 1,2-diethoxyethane. Examples of cyclic ester solvents include γ-butyrolactone. Examples of linear ester solvents include methyl acetate. Examples of fluorinated solvents include fluoroethylene carbonate, methyl fluoropropionate, fluorobenzene, fluoroethyl methyl carbonate, and fluorodimethylene carbonate. One nonaqueous solvent selected from these may be used alone as the nonaqueous solvent, or a mixture of two or more nonaqueous solvents selected from these may be used. In the nonaqueous electrolyte solution, at least one fluorinated solvent selected from the group consisting of fluoroethylene carbonate, methyl fluoropropionate, fluorobenzene, fluoroethyl methyl carbonate, and fluorodimethylene carbonate may be contained.

Examples of lithium salts include LiPF₆, LiBF₄, LiSbF₆, LiAsF₆, LiSO₃CF₃, LiN(SO₂CF₃)₂, LiN(SO₂C₂F₃)₂, LiN(SO₂CF₃)(SO₂C₄F₉), and LiC(SO₂CF₃)₃. One lithium salt selected from these may be used alone as the lithium salt, or a mixture of two or more lithium salts selected from these may be used. The concentration of the lithium salt is, for example, in the range of 0.5 to 2 mol/liter.

As the gel electrolyte, an electrolyte obtained by soaking at least one polymeric material with a nonaqueous electrolyte solution can be used. At least one selected from the group consisting of polyethylene oxide, polyacrylonitrile, polyvinylidene fluoride, polymethyl methacrylate, and polymers having ethylene oxide linkages may be used as the polymeric material.

The cation that forms the ionic liquid may be, for example, an aliphatic linear quaternary cation, such as a tetraalkylammonium or tetraalkylphosphonium, an aliphatic cyclic ammonium, such as a pyrrolidinium, morpholinium, imidazolinium, tetrahydropyridinium, piperazinium, or piperidinium, or a nitrogen-containing heterocyclic aromatic cation, such as a pyridinium or imidazolium. The anion that forms the ionic liquid may be, for example, PF₆⁻, BF₄⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)⁻, or C(SO₂CF₃)₃⁻. The ionic liquid may contain a lithium salt.

In at least one selected from the group consisting of the positive electrode active material layer 17, the electrolyte layer 13, and the negative electrode active material layer 11, a binder may be contained for the purpose of improving adhesion between particles. Binders are used to improve binding in materials forming an electrode. Examples of binders include polyvinylidene fluoride, polytetrafluoroethylene, polyethylene, polypropylene, aramid resins, polyamides, polyimides, polyamide-imides, polyacrylonitrile, polyacrylic acid, polymethyl acrylate, polyethyl acrylate, polyhexyl acrylate, polymethacrylic acid, polymethyl methacrylate, polyethyl methacrylate, polyhexyl methacrylate, polyvinyl acetate, polyvinylpyrrolidone, polyethers, polyethersulfones, hexafluoropolypropylene, styrene butadiene rubber, and carboxymethyl cellulose. As the binder, furthermore, copolymers of two or more materials selected from tetrafluoroethylene, hexafluoroethylene, hexafluoropropylene, perfluoroalkyl vinyl ethers, vinylidene fluoride, chlorotrifluoroethylene, ethylene, propylene, pentafluoropropylene, fluoromethyl vinyl ether, acrylic acid, and hexadiene can be used. Alternatively, a mixture of two or more selected from these may be used as the binder.

A battery 100 made with composite active material particles 30 can be manufactured by, for example, the method described below.

A powder of a solid electrolyte is put into a ceramic die. An electrolyte layer 13 is formed by pressing the powder of a solid electrolyte. On one side of the electrolyte layer 13, a powder of a negative electrode material is placed. A negative electrode active material layer 11 is formed on top of the electrolyte layer 13 by pressing the powder of a negative electrode material. The negative electrode material contains multiple composite active material particles 30 and a second solid electrolyte 40. The negative electrode material may contain a conductive additive 50. On the other side of the electrolyte layer 13, a powder of a positive electrode material is placed. A positive electrode active material layer 17 is formed by pressing the powder of a positive electrode material. This gives a power-generating element including a negative electrode active material layer 11, an electrolyte layer 13, and a positive electrode active material layer 17.

A negative electrode current collector 12 and a positive electrode current collector 18 are placed on the top and bottom, respectively, of the power-generating element, and a current-collecting lead wire is attached to each of the negative electrode current collector 12 and positive electrode current collector 18. This yields a battery 100.

A battery 100 made with composite active material particles 30 can also be manufactured by a wet process. In a wet process, for example, a coating is formed by applying a negative electrode slurry containing multiple composite active material particles and a second solid electrolyte 40 onto a current collector. Then the coating is pressed by passing it between rollers or through a flat press, with the rollers or press heated to a temperature higher than or equal to 120° C. This gives a negative electrode 210. An electrolyte layer 13 and a positive electrode 220 are produced in the same manner. Then the negative electrode 210, the electrolyte layer 13, and the positive electrode 220 are laminated in this order. This yields a battery 100.

The battery 100 in this embodiment can be configured as batteries in various shapes, such as coin-shaped, cylindrical, square, sheet-shaped, button-shaped, flat-plate, and multilayer.

It should be noted that the present disclosure is not limited to the above embodiments. The above embodiments are provided by way of example, and anything having substantially the same configuration as and offering advantages similar to those of a technical idea described in the claims of the present disclosure is encompassed in the technical scope of the present disclosure.

### EXAMPLES

The details of certain aspects of the present disclosure will now be described using examples and a comparative example.

### Preparation of a Sulfide Solid Electrolyte

In an Ar-atmosphere glove box with a dew point of lower than or equal to −60° C., Li₂S and P₂S₅ were weighed out in such a manner that Li₂S:P₂S₅=75:25 as a molar ratio. These materials were ground and mixed in a mortar to give a mixture. Then the mixture was subjected to milling treatment using a planetary ball mill (manufactured by Fritsch GmbH; model P-7) under the conditions of 10 hours and 510 rpm, giving a vitreous solid electrolyte. The vitreous solid electrolyte was heat-treated in an inert atmosphere under the conditions of 270 degrees and 2 hours. Through this, a Li₂S—P₂S₅ powder, which was a glass-ceramic sulfide solid electrolyte, was obtained. A Li₂S—P₂S₅ powder may be hereinafter referred to simply as “LPS.”

### Example 1

### Production of Composite Active Material Particles

As the active material, a Si powder (3N, ground to 2.5 μm) was prepared. As the oxide, a Li₂SiO₃ powder (2N, ground to 10 μm) was prepared. The Si powder and the Li₂SiO₃ powder were weighed out in such a manner that the Si powder: the Li₂SiO₃ powder=1:1 as a ratio by mass. These powders were mixed in an Ar-atmosphere glove box with a dew point of lower than or equal to −60° C., giving a first powder mixture. The first powder mixture was placed in the pod (made of SUS; volume, 45 mL) of a planetary ball mill (manufactured by Fritsch GmbH; model P-7). Sixty grams of SUS balls (diameter, 5 mm) were added to the pod, the lid was closed, and the first powder mixture was subjected to grinding treatment under the conditions of 600 rpm and 48 hours. Then coarse particles were removed by passing the treated powder through a mesh with 45-μm openings. Fine particles, furthermore, were removed using a sieve with a smaller mesh size, and thereby the average particle size of the powder was adjusted to approximately 20 μm. Through this, base particles were obtained.

As the first solid electrolyte, a Li_{6.25}La₃Zr₂Al_{0.25}O₁₂ powder (manufactured by Toshima Manufacturing Co., Ltd.; 3N), which was a garnet solid electrolyte, was prepared. A Li_{6.25}La₃Zr₂Al_{0.25}O₁₂ powder may be hereinafter referred to simply as “LLZAl.” The LLZAl powder was added to the base particles in such a manner that the percentage of the mass of the LLZAl powder to the mass of the finished composite active material particles would be 10%, giving a second powder mixture. The second powder mixture was placed in the pod (made of SUS; volume, 45 mL) of a planetary ball mill (manufactured by Fritsch GmbH; model P-7). Forty grams of zirconia balls (diameter, 5 mm) were added to the pod, and the lid was closed. By treating the mixture under the conditions of 400 rpm and 8 hours, the base particles were coated. Through this, composite active material particles of Example 1 were obtained.

The composite active material particles of Example 1 had the structure described with reference to FIG. 1.

### Measurement of the Average Thickness of the First Solid Electrolyte

The average thickness of the first solid electrolyte for the composite active material particles of Example 1 measured by the method described above was 10 nm.

### Preparation of a Negative Electrode Material

LPS was used as the second solid electrolyte. In an Ar-atmosphere glove box with a dew point of lower than or equal to −60° C., the composite active material particles of Example 1 and LPS were mixed in a ratio by mass of 100:28.6 to give a mixture. In the mixture, the ratio between the total of the masses of the base particles, the first solid electrolyte (LLZAl), and the second solid electrolyte (LPS) and the total of the masses of the first solid electrolyte and the second solid electrolyte was 7:3. The mixture was mixed with 10% by mass, in relation to the first solid electrolyte and the second solid electrolyte, VGCF-H (manufactured by Showa Denko K.K.) added to it. Through this, a negative electrode material of Example 1 was obtained. “VGCF” is a registered trademark of Showa Denko K.K.

### Preparation of a Positive Electrode Material

In an Ar-atmosphere glove box with a dew point of lower than or equal to −60° C., Li(Ni_{0.33}C_{00.33}Mn_{0.33})O₂ and LPS were mixed in a ratio by mass of 7:3. Through this, a positive electrode material was obtained. The positive electrode material is common to the examples and the comparative example.

### Fabrication of a Secondary Battery

First, 4 mg of LPS and 10 mg of the negative electrode material were placed in an electrically insulating casing, and these materials were pressure-molded at a pressure of 360 MPa to give a laminate of a negative electrode active material layer and an electrolyte layer.

Then copper foil (thickness, 12 μm) was placed on top of the negative electrode active material layer. These layers were pressure-molded at a pressure of 360 MPa to give a negative electrode of Example 1.

The negative electrode of Example 1 had the structure described with reference to FIG. 5.

Then 100 mg of the positive electrode material was layered on top of the electrolyte layer, and these layers were pressure-molded at a pressure of 360 MPa to give a laminate including a negative electrode, an electrolyte layer, and a positive electrode active material layer.

Then aluminum foil was placed on top of the positive electrode active material layer. These layers were pressure-molded at a pressure of 360 MPa to give a laminate composed of a positive electrode, an electrolyte layer, and a negative electrode.

Then stainless-steel current collectors were placed on the top and bottom of the laminate, and current-collecting lead wires were attached to the current collectors.

Finally, the electrically insulating casing was tightly closed using an electrically insulating ferrule, and thereby the inside of the electrically insulating casing was insulated from the outside atmosphere. In this manner, a battery of Example 1 was fabricated.

### Example 2

### Production of Composite Active Material Particles

The base particles of Example 1 were used as the base particles. LPS was used as the first solid electrolyte. An LPS powder was added to the base particles in such a manner that the percentage of the mass of the LPS powder to the mass of the base particles would be 10%, giving a powder mixture. The powder mixture was placed in the pod (made of SUS; volume, 45 mL) of a planetary ball mill (manufactured by Fritsch GmbH; model P-7). Forty grams of zirconia balls (diameter, 5 mm) were added to the pod, and the lid was closed. By treating the mixture under the conditions of 400 rpm and 8 hours, the base particles were coated. Through this, composite active material particles of Example 2 were obtained.

The composite active material particles of Example 2 had the structure described with reference to FIG. 1.

### Measurement of the Average Thickness of the First Solid Electrolyte

The average thickness of the first solid electrolyte for the composite active material particles of Example 2 measured by the method described above was 10 nm.

### Preparation of a Negative Electrode Material

A negative electrode material of Example 2 was prepared by the same method as in Example 1, except that the composite active material particles of Example 2 were used instead of the composite active material particles of Example 1.

### Fabrication of a Secondary Battery

A battery of Example 2 was fabricated by the same method as in Example 1, except that the negative electrode material of Example 2 was used instead of the negative electrode material of Example 1.

### Comparative Example 1

### Production of Composite Active Material Particles

The active material and the oxide were the same as in Example 1. The Si powder and the Li₂SiO₃ powder were weighed out in such a manner that the Si powder: the Li₂SiO₃ powder=1:1 as a ratio by mass. These powders were mixed in an Ar-atmosphere glove box with a dew point of lower than or equal to −60° C., giving a powder mixture. The powder mixture was placed in the pod (made of SUS; volume, 45 mL) of a planetary ball mill (manufactured by Fritsch GmbH; model P-7). Sixty grams of SUS balls (diameter, 5 mm) were added to the pod, the lid was closed, and the powder mixture was subjected to grinding treatment under the conditions of 600 rpm and 48 hours. Then coarse particles were removed by passing the treated powder through a mesh with 45-μm openings. Fine particles, furthermore, were removed using a sieve with a smaller mesh size, and thereby the average particle size of the powder was adjusted to approximately 20 μm. Through this, composite active material particles of Comparative Example 1 were obtained. The composite active material particles of Comparative Example 1, therefore, were not covered with the first solid electrolyte (LLZAl).

### Preparation of a Negative Electrode Material

In an Ar-atmosphere glove box with a dew point of lower than or equal to −60° C., the composite active material particles of Comparative Example 1 and LPS were mixed in a ratio by mass of 7:3 to give a mixture. The mixture was mixed with 10% by mass VGCF-H (manufactured by Showa Denko K.K.) added to it. Through this, a negative electrode material of Comparative Example 1 was obtained.

### Fabrication of a Secondary Battery

A battery of Comparative Example 1 was fabricated by the same method as in Example 1, except that the negative electrode material of Comparative Example 1 was used instead of the negative electrode material of Example 1.

### Charge-Discharge Test

Using the batteries of the examples and the comparative example, a charge-discharge test was conducted under the following conditions. It should be noted that the theoretical capacities of the batteries of the examples and the comparative example were identical with one another.

The batteries were placed in a temperature-controlled chamber at 25° C.

Constant-current charging was performed at a current value of 770 μA, which corresponded to a rate of 0.05 C (20-hour rate) in relation to the theoretical capacity of the batteries, and terminated at a voltage of 4.2 V.

Then constant-current discharging was performed at a current value of 770 μA, corresponding to a rate of 0.05 C (20-hour rate), and terminated at a voltage of 2 V.

Through the steps up to this point, the initial irreversible capacity loss was eliminated.

Again, constant-current charging was performed at a current value of 770 μA, corresponding to a rate of 0.05 C (20-hour rate) in relation to the theoretical capacity of the batteries, and terminated at a voltage of 4.2 V.

Then constant-current discharging was performed at a current value of 770 μA, corresponding to a rate of 0.05 C (20-hour rate), and terminated at a voltage of 2 V.

Additionally, constant-current charging was performed at a current value of 770 μA, corresponding to a rate of 0.5C (2-hour rate) in relation to the theoretical capacity of the batteries, and terminated at a voltage of 4.2 V.

Then constant-current discharging was performed at a current value of 770 μA, corresponding to a rate of 0.05 C (20-hour rate), and terminated at a voltage of 2 V.

Based on the results of the above charge-discharge test, the charge efficiency E, given by 100×(charge capacity at 0.5C/charge capacity at 0.05 C), was calculated. A higher value of the charging efficiency E indicates better high-rate charging efficiency for the battery. The results are presented in Table 1.

TABLE 1

| | | | Comparative |
|---|---|---|---|
| | Example 1 | Example 2 | Example 1 |
| Charging efficiency E (%) | 58.5 | 39.3 | 33.3 |

### DISCUSSION

The batteries of Examples 1 and 2 exhibited a higher charging efficiency E compared with the battery of Comparative Example 1. For the batteries of Examples 1 and 2, separation between the composite active material particles and the second solid electrolyte was limited presumably because silicon particles expanded through charging clustered inside the composite active material particles and because the first solid electrolyte, which does not expand, was present at the interface with the second solid electrolyte. It appears that this allowed for good interfacial contact to be maintained during charging and enabled unhindered intercalation of lithium ions into the composite active material particles, resulting in an improved charging efficiency E.

In particular, the battery of Example 1, in which a garnet solid electrolyte was used as the first solid electrolyte, achieved a high charging efficiency E compared with that of Example 2.

In contrast, the charging efficiency E of the battery of Comparative Example 1 was lower than 35%. For the battery of Comparative Example 1, separation between the composite active material particles and the second solid electrolyte was promoted by the expansion and contraction of silicon particles associated with charging and discharging presumably because numerous silicon particles were exposed on the outer surface of the composite active material particles. It appears that this led to hindered intercalation of lithium ions into the composite active material particles, resulting in a reduction in charging efficiency E.

The technologies according to aspects of the present disclosure are useful to, for example, lithium batteries, such as all-solid-state lithium secondary batteries and nonaqueous electrolyte lithium-ion batteries.

What is claimed is:

1. A composite active material particle comprising:
an oxide phase containing an oxide;
a plurality of active material domains containing an active material and dispersed in the oxide phase; and
at least one first solid electrolyte having a composition different from a composition of the oxide, wherein
the first solid electrolyte covers at least part of a surface of a base particle composed of the oxide phase and the plurality of active material domains.

2. The composite active material particle according to claim 1, wherein
the first solid electrolyte has a garnet-type crystal structure.

3. The composite active material particle according to claim 2, wherein
the first solid electrolyte includes at least one selected from the group consisting of Li₂La₃Zr₂O₁₂, Li₇₋₃ₓLa₃Zr₂AlₓO₁₂, where 0≤x<0.3, Li_{7-y}La₃Zr_{2-y}Nb_{y}O₁₂, where 0≤y<0.3, and Li_{7-z}La₃Zr_{2-z}Ta₂O₁₂, where 0≤z<0.5.

4. The composite active material particle according to claim 1, wherein
the active material includes a material that forms an alloy with lithium.

5. The composite active material particle according to claim 1, wherein
the active material includes at least one selected from the group consisting of elemental silicon and SiOₐ, where 0<a<2.

6. The composite active material particle according to claim 1, wherein
the oxide phase is amorphous.

7. The composite active material particle according to claim 1, wherein
the oxide phase contains a lithium silicate.

8. The composite active material particle according to claim 7, wherein
the lithium silicate has a composition represented by Li_{2b}SiO_{(2+b)}, where 0<b≥2.

9. A battery comprising:
a positive electrode;
a negative electrode; and
an electrolyte layer located between the positive electrode and the negative electrode, wherein
the negative electrode contains the composite active material particle according to claim 1.

10. The battery according to claim 9, wherein
the negative electrode further contains at least one second solid electrolyte having a composition different from the compositions of the oxide and the first solid electrolyte.

11. The battery according to claim 10, wherein
the second solid electrolyte includes a sulfide solid electrolyte.

12. The battery according to claim 9, wherein
the electrolyte layer contains at least one third solid electrolyte.

13. A method for manufacturing a composite active material particle, the method comprising:
coating at least part of a surface of a base particle, the base particle having a structure in which a plurality of active material domains containing an active material are dispersed in an oxide phase, with at least one first solid electrolyte.

14. The method according to claim 13 for manufacturing a composite active material particle, wherein
the at least part of the surface of the base particle is coated with the at least one first solid electrolyte by a solid-phase process.
